(19) United States
(12) Patent Application Publication
(10) Pub. No.: US 2016/0047243 A1
(43) Pub. Date: Feb. 18, 2016

(54) EXPANDER FOR A HEAT ENGINE

(71) Applicants: Paul VAN DE LOO, Thebarton (AU); Nicholas Luke SCHULTZ, Highbury (AU)

(72) Inventors: Paul VAN DE LOO, Thebarton (AU); Nicholas Luke SCHULTZ, Highbury (AU)

(73) Assignee: Cogen Microsystems Pty Ltd, Thebarton, SA (AU)

(21) Appl. No.: 14/409,873

(22) PCT Filed: Jun. 26, 2012
(86) PCT No.: PCT/AU2012/000740

§ 371 Date: Oct. 19, 2015

(51) Int. Cl. F01B 9/02; F02G 1/043; F01B 29/10

(52) U.S. Cl. CPC F01B 9/02; F01B 29/10; F02G 1/043

(57) ABSTRACT

An expander for a heat engine, the expander being capable of converting a high pressure gaseous working fluid to useful work, the expander including: •high pressure working fluid supply means; •at least one reciprocating piston reciprocating in a cylinder between top-dead-centre (TDC) and bottom-dead-centre (BDC) with a long dwell time at TDC; •a working fluid inlet valve that opens and closes to introduce, while open, high pressure working fluid from the working fluid supply means into an expansion chamber in the cylinder at or near TDC; •power transfer means that transfers work done on a piston by the working fluid to a form of useful work output; and •an exhaust valve to release expanded working fluid from the expansion chamber to a volume of low pressure working fluid; wherein piston travel is small during transition of the inlet valve from open to closed and from closed to open.

### FIELD OF THE INVENTION

The present invention relates to expanders for use in heat engines. The invention is limited to expanders that incorporate or utilise a high pressure working fluid supply means, as opposed to expanders that rely on internal combustion for the generation of the high pressure in a working fluid.

### BACKGROUND OF THE INVENTION

The expander is a key element of a heat engine and its role is to convert the energy in a high pressure working fluid to mechanical energy by allowing the working fluid to expand and do work as it does so. In the broadest form, heat engines are simply devices that are able to convert thermal energy to mechanical work, which thus covers a broad range of engines such as steam engines and diesel engines, and other engines often referred to by the thermodynamic cycle that they utilize (such as a Rankine cycle engine or a Stirling cycle engine).

The use of Rankine cycle engines to convert heat to mechanical power is well known. Large scale Rankine cycle engines generally use continuous flow expanders, such as turbines, for the expansion stage, whereas small scale Rankine cycle engines generally employ a reciprocating expander (such as a piston and cylinder arrangement) as turbines and the like are less efficient on a small scale.

However, such small scale Rankine cycle engines generally have efficiencies significantly less than that of typical steam turbines. In our U.S. Pat. No. 7,188,474, issues causing such low efficiencies are outlined and a more efficient heat engine is described. In particular, the need to open and close the inlet valve quickly is emphasised. Minimising the time that the inlet valve is partially open minimises the amount of throttling of the high pressure working fluid and the associated loss of energy. The main improvement described is an inlet valve that can provide short and sharp “cut-off”, although an exhaust valve mounted in the piston is also described which also has a number of advantages. It describes the advantage of a short “cut-off” in providing for a large expansion ratio which is advantageous for high pressure working fluids. In practice, the engine described works well but the complexity (and hence also cost) and durability of the inlet valve and the exhaust valve have proven to be problematic.

The aim of the present invention is to provide an expander for a heat engine from which these difficulties are eliminated or are at least significantly reduced, whilst maintaining good efficiency of operation.

The expander of the present invention has been developed for use in a heat engine intended for applications such as the conversion of solar thermal energy to useful work. An example is the collection of solar thermal energy using a suitable solar collector, conversion of this energy to mechanical energy using the heat engine, followed by conversion of this energy to electricity using an electrical generator, for the purpose of supplying a small domestic or commercial building with electricity.

Another application is the recovery of heat that is otherwise wasted, such as heat from cooling water and exhaust gas from internal combustion engines, to generate useful energy. The heat can be supplied to a heat engine incorporating the expander of the present invention, which generates mechanical energy which can be used directly, or converted to electrical energy with the aid of a suitable electrical generator.

Of course, the expander of the present invention is not to be limited only to these applications. Indeed it can be used to provide mechanical work from any gaseous working fluid provided to the expander under pressure.

Before turning to a summary of the present invention, it must be appreciated that any description of prior art is provided merely as background to explain the context of the invention. It is not to be taken as an admission that any of the material referred to was published or known, or was a part of the common general knowledge in Australia or elsewhere.

### SUMMARY OF THE INVENTION

The present invention provides an expander for a heat engine, the expander being capable of converting a high pressure gaseous working fluid to useful work, the expander including:
high pressure working fluid supply means;
at least one reciprocating piston reciprocating in a cylinder between top-dead-centre (TDC) and bottom-dead-centre (BDC) with a long dwell time at TDC;
a working fluid inlet valve that opens and closes to introduce, while open, high pressure working fluid from the working fluid supply means into an expansion chamber in the cylinder at TDC;
power transfer means that transfers work done on a piston by the working fluid to a form of useful work output; and
an exhaust valve to release expanded working fluid from the expansion chamber to a volume of low pressure working fluid;
   wherein piston travel is small during transition of the inlet valve from open to closed and from closed to open.

The present invention also provides a method of operating an expander for a heat engine, the expander being capable of converting a high pressure gaseous working fluid to useful work, the method including:
reciprocating at least one piston in a cylinder between top-dead-centre (TDC) and bottom-dead-centre (BDC) with a long dwell time at TDC;
opening an inlet valve to introduce working fluid from a high pressure working fluid supply means into an expansion chamber in the cylinder when the piston is at TDC;
continuing movement of each piston from TDC to BDC under the influence of the working fluid in the expansion chamber, expansion of the working fluid in the expansion chamber thereby doing work on each piston;
closing the inlet valve; and
releasing expanded working fluid from the expansion chamber to a volume of low pressure working fluid via an exhaust valve;
the work on the piston being delivered in a form of useful work output by power transfer means;
   wherein piston travel is small during transition of the inlet valve from open to closed and from closed to open.

The above reference to the expander of the present invention including “at least one reciprocating piston reciprocating in a cylinder” is intended to include embodiments where multiple cylinders each have a piston reciprocating therewithin, there being the normal subsequent association of each piston/cylinder arrangement with respective inlet valves, exhaust valves and expansion chambers, and the like.

However, it should be appreciated that this reference is also intended to include embodiments where two pistons are arranged in a single cylinder, the pistons being arranged in an opposed co-linear configuration. In this embodiment, it will be preferred for the pistons to be arranged such that the space between the pistons at TDC defines a single expansion chamber, there then being a single inlet valve configured to open and close to introduce, while open, the high pressure working fluid from a single high pressure working fluid supply means into the single expansion chamber. The working fluid in that single expansion chamber would then do work on both pistons to generate useful work output from both via either one or two power transfer means.

The term “dwell time” will be used repeatedly in this specification in relation to the motion of the reciprocating pistons. This term does not imply that the pistons are stationary for some period of time. A skilled addressee will appreciate that the term “dwell time” is used to describe the time that the piston resides within some arbitrary distance from its extreme end of travel, moving at a speed less than its average speed. It is a term that can be used with regard to each end of the travel of the pistons in an expander of a heat engine, being both TDC and BDC.

In this respect, an important aspect of the present invention is that the reciprocating motion of each piston is characterised by a “long” dwell time at or near TDC. For a piston in the expander of the present invention, the reference in this specification to a “long” dwell time relies on a comparison of the inventive expander operating at a constant crankshaft speed with a comparative expander (configured with the same expansion ratio and operating with a constant crankshaft speed) whose reciprocating piston moves with simple harmonic motion, which a skilled addressee will appreciate is of sinusoidal form. A “long” dwell time means a dwell time that is longer (by any amount) than the dwell time that would be associated with the simple harmonic motion of a piston in such a comparative expander.

In relation to the term “dwell time”, it will also be appreciated that the dwell time of a piston in an expander is notionally equivalent to its “dwell angle”, primarily due to such expanders desirably operating with constant crankshaft speeds. In this respect, it is generally the case that fluctuations in crankshaft speed are undesirable in engines, this being the reason that many engines utilise flywheels to maintain constant crankshaft speeds. As a result, it would be possible to use the terms “dwell time” and “dwell angle” interchangeably—throughout this specification the term “dwell time” will be used, although the timing diagrams described later will be illustrated with respect to dwell angle.

Comparisons with simple harmonic motion also permit use of the word “small” in the phrase “wherein piston travel at TDC is small”. Reference can be made to the amount of piston travel that would occur in a comparative expander if its reciprocating piston was again following simple harmonic motion (and again with the same expansion ratio and operating with a constant crankshaft speed). For the expander of the present invention, the word “small” thus means an amount of travel that is less (by any amount) than the piston travel that would be expected for the same crank angle during simple harmonic motion of a reciprocating piston in such a comparative expander.

In a preferred form, the expander of the present invention incorporates a crank-slider mechanism, which is a subset of the class of mechanisms termed four-bar linkages. The crank-slider mechanism includes a crankshaft, a connecting rod and a piston in a cylinder in which the piston can move axially. In such a mechanism, if the connecting rod is very long relative to the crank radius, then the motion of the piston will approach simple harmonic motion, with simple harmonic motion being achieved with an infinitely long connecting rod. However, in practice it is obviously undesirable to have a very long connecting rod as the heat engine incorporating the expander becomes large, so simple harmonic motion is difficult to achieve (without adopting alternative mechanisms and configurations).

In traditional expanders that utilise crank-slider mechanisms, the motion of the piston deviates from simple harmonic motion by way of a long dwell time at BDC and a short dwell time at TDC. However, a short dwell time at TDC is undesirable, as there is less time for the flow through the inlet valve to provide working fluid into the expansion chamber.

For example, for traditional expanders used in single stage high efficiency engines, the expansion ratio would be large, meaning that the end of the inlet or “admission” period would be at a point where the piston had travelled only 1/10 or less of its stroke. The inlet valve would thus be required to open, to introduce a new charge of working fluid, and then close, in the very short time corresponding to the crank rotation angle corresponding to the portion of piston travel, from TDC to 1/10 of its stroke downwards. Ideally the peak valve travel would be large so that the peak inlet valve opening was large, so as not to appreciably restrict the incoming working fluid. However, this would require large peak valve accelerations and velocities due to the very short duration of the inlet valve opening, which in practice is hard to achieve with a durable valve mechanism.

The present inventor has also recognised that there is a risk of the throttling of working fluid flow, with attendant energy and efficiency losses, at inlet valve opening. Ideally, as an inlet valve opens, the piston will be precisely at TDC, with any working fluid remaining in the expansion chamber at the same pressure as that supplied by the high pressure working fluid supply means. This ensures that there is then no tendency for working fluid to pass into the expansion chamber from the working fluid supply means through a partially open valve as such a flow would be subject to throttling, due to the small valve aperture whilst it is opening (resulting again in energy loss and hence reduced efficiency of the expander).

By virtue of the present invention, the long dwell time of each piston, combined with the speed of the opening and closing of the inlet valve, results in the piston travel being desirably small during transition of the inlet valve from closed to open. Given that there is thus very little downward movement of the piston in the cylinder whilst the inlet valve is opening, the volume of the expansion chamber is not substantially increasing, resulting in a further minimisation of any throttling of the working fluid flow that might arise from an increasing volume drawing in working fluid through a partially open inlet valve.

Another benefit provided by the present invention is related to the amount of piston travel that occurs when the inlet valve is in the process of closing. In general terms, while an inlet valve is closing its ability to introduce additional working fluid to an expansion chamber, without developing a large pressure drop across the valve, is diminishing. Rapid piston motion during this time increases the quantity of working fluid that must be introduced to the expansion chamber if cylinder pressure is to be kept at or near working fluid supply means pressure. This further exacerbates the magnitude of the pressure drop, or “throttling”, which can develop across the inlet valve during closing.

In this respect, flow of working fluid through an inlet valve experiencing such throttling represents a direct loss of energy, adversely impacting on engine efficiency, which is to be avoided. The present inventor has found that by minimising the amount of piston travel coinciding with the period of inlet valve closing, the problems of throttling are minimised or completely avoided.

The long dwell time of each reciprocating piston at TDC may be provided by any suitable mechanism capable of providing the asymmetry of a long dwell time at TDC (compared with simple harmonic motion) rather than at BDC as described above. For example, a mechanism such as a four bar linkage is preferable. In this respect, while it may be at least theoretically possible to achieve the long dwell time by manipulating crankshaft speed (such that the crankshaft speed is no longer constant, and in particular being relatively slower at the angle of rotation coinciding with the piston position at which a long dwell is desired), this is not regarded as desirable and thus is not a preferred embodiment of the present invention.

In one form, the long dwell time of each reciprocating piston at TDC may be provided by a four bar linkage in which a piston is connected via a connecting rod to a crankshaft. In most crank-slider mechanisms though, a crank would normally act on a connecting rod to push a piston towards TDC and then pull the piston away from TDC towards BDC. However, in a preferred form of the invention, a preferred crank-slider mechanism is configured such that a crank acts on a connecting rod to pull a piston towards TDC and then to push the piston away from TDC towards BDC. This then effectively reverses the traditional TDC and BDC motions of the piston, providing the desired long dwell time at TDC relative to the dwell time at BDC.

In one particular form, this can be achieved by providing a piston having a crank-slider mechanism that bridges a crankshaft. In this form, the piston preferably has an elongate body with a forward end and a rearward end, there being a piston head at its forward end that provides the piston's working face adjacent the expansion chamber. The crankshaft is preferably configured to be between the forward end and the rearward end of the piston (hence the above reference to the piston having a crank-slider mechanism that “bridges” the crankshaft), such that its connecting rod (or connecting rods) are configured to extend from the crankshaft towards the rearward end, with the operative connection of the connection rod to the piston being at or near the rearward end. Again, this effectively reverses the traditional TDC and BDC motions of the piston, providing the desired long dwell time at TDC relative to the dwell time at BDC.

In this form, the piston may be formed by a piston head at its forward end and a cross member at its rearward end, with a suitable support member (such as a number of rigid columns) therebetween joining the piston head to the cross member. Preferably, the configuration of such a piston is such that the overall shape of the piston is suitable for the desired reciprocating motion required within the cylinder of an expander. For example, in one form it may be desirable for the piston to itself have a generally cylindrical configuration so that it will completely lie within, and reciprocate within, the cylinder, although in other forms of the invention this may not be necessary.

In a preferred form of the invention, and for the reasons outlined above, a flywheel of substantial rotational inertia at the desired operating speed is used to maintain the rotational speed of the crankshaft substantially constant.

However, other forms of crank-slider mechanisms may also be used to provide the desired long dwell time at TDC referred to above. One of these is a rhombic drive mechanism, which is commonly used to drive two pistons in Stirling engines, one half of the mechanism driving the power piston, the other half driving the displacer piston. Thus, in another form of the present invention, one half of a rhombic drive mechanism is used to convert reciprocating piston motion, with large dwell time at TDC, to substantially constant rotational motion of the crankshaft.

In another form of the invention, again utilising a crank-slider mechanism having a reciprocating piston within a cylinder, the piston being connected via a connecting rod to a crankshaft, the axis of rotation of the crankshaft is ideally offset from the centreline of the cylinder. In this form, the eccentricity results in TDC moving slightly closer to the commencement of the dwell period, allowing the inlet valve to be opened slightly earlier in the dwell, providing more time for the working fluid to enter the expansion chamber.

In yet another form of the present invention, each piston and the inlet valve may be operatively linked such that the timing and speed of the opening and closing of the inlet valve occur to the desired extent in response to movement of the reciprocating piston(s). For example, and as will be described below in relation to embodiments of the present invention, such an operative link might be provided by the inlet valve and a piston utilising a common crankshaft, offset and/or geared as necessary, such that reciprocating motion of the piston directly causes the opening and closing of the inlet valve at the appropriate time and speed.

In a preferred form of the invention, the inlet valve motion is also a reciprocating motion. This form of the invention provides an inlet valve that includes a valve actuation mechanism that provides a deviation from simple harmonic motion, such that the dwell time at the end of travel associated with the inlet valve being open is short relative to the dwell time at the other end of travel. This increases the speed of valve motion at both opening and closing and so minimises the amount of working fluid throttling and hence improves efficiency as explained previously.

In this preferred form, the valve actuation mechanism may be a crank-slider mechanism where the slider forms a valve spool which slides in a sleeve which has ports in the wall that, when aligned with a recess in the spool, allow working fluid to flow into the expansion chamber. The mechanism preferably has a connecting rod that is longer than the crankshaft crank radius and is configured such that the dwell of the valve spool, which is driven by the crankshaft via the connecting rod, is short relative to the dwell time at the other end of spool travel.

The present invention also includes an exhaust valve to allow expanded working fluid to exit the expansion chamber when it is fully expanded. This valve may take one of many forms known to those skilled in the art, such as a slide valve, rotary valve or poppet valve actuated by suitable actuation means at the desired time provided by suitable timing means. In a preferred form of the invention, the exhaust valve opens at or just after BDC and remains open until just before TDC.

The present invention allows for high expansion ratios to be achieved, the expansion ratio being defined as the volume of expanded working fluid in the expansion chamber at BDC or when the exhaust valve opens, whichever occurs first, divided by the volume of working fluid in the expansion chamber at the point that the inlet valve closes. A high expansion ratio is desirable as it allows more of the pressure contained in the working fluid to do work on the piston, rather than being wasted by expanding through the exhaust valve when it opens. Under some conditions, such as in a steam engine when full boiler temperature has not been reached, the working fluid in the expansion volume may be fully expanded prior to the exhaust valve opening. This is undesirable, as the piston must do suction work to over-expand this working fluid.

Finally, it will be appreciated that the type of working fluid utilised in the expander of the present invention will be dependent on the application that the expander is put to, but it may be steam, compressed air, refrigerant vapour or other organic substance vapour, or any other gas, or mixture that is substantially gas.

Of course, it will also be appreciated that the power transfer means will ordinarily consist of a piston, with its connecting rod connecting it to a crankshaft suitable for interfacing to a load such that the rotary motion of the crankshaft can drive the load. The load may be an alternator to generate electricity, a pump to pump water, or any other device which can employ rotary mechanical power for a useful purpose.

### BRIEF DESCRIPTION OF THE DRAWINGS

Having briefly described the general concepts involved with the present invention, several preferred embodiments of an expander in accordance with the present invention will now be described. However, it is to be understood that the following description is not to limit the generality of the above description.

In the drawings:

FIG. 1 is a plan schematic view of a first preferred embodiment of the present invention;

FIG. 2 is a side schematic view of the first preferred embodiment;

FIG. 3 shows a side schematic view of a second preferred embodiment of the present invention;

FIG. 3a shows a side schematic view of the second preferred embodiment with a minor modification;

FIG. 4 shows a side schematic view of a third preferred embodiment of the present invention;

FIG. 5 shows a general timing diagram for the present invention;

FIG. 6 shows a timing diagram with a comparison of simple harmonic motion, conventional motion, and motion for embodiments of the present invention;

FIG. 7 shows a timing diagram with a dwell time comparison for simple harmonic motion and motion for embodiments of the present invention; and

FIG. 8 shows a timing diagram with a piston travel comparison (during valve opening and closing) for simple harmonic motion and motion for embodiments of the present invention.

### DETAILED DESCRIPTION OF THE DRAWINGS

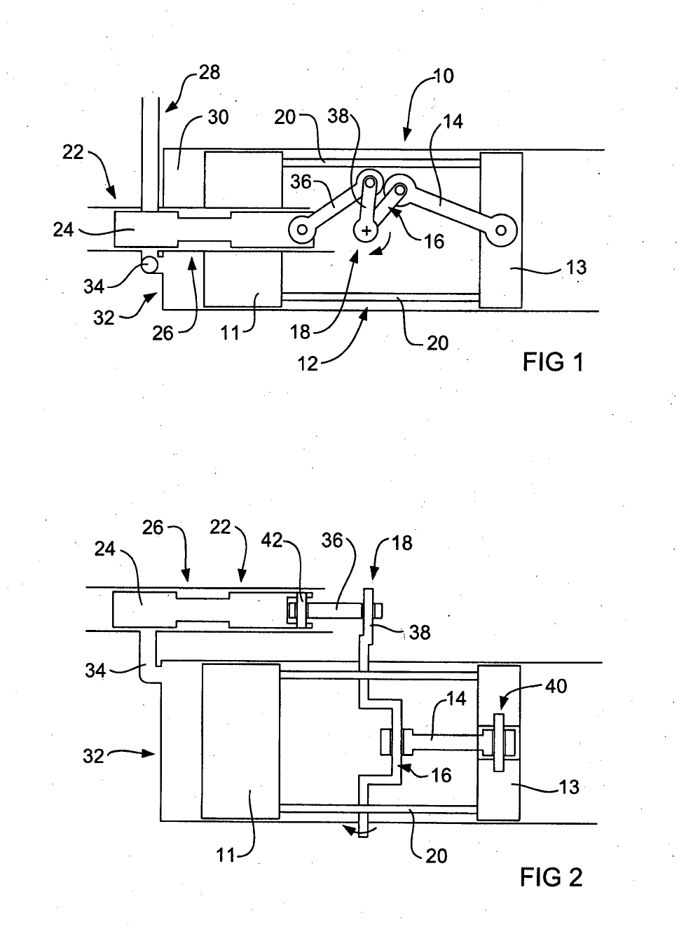

Referring to FIG. 1, the first embodiment of the expander of the present invention includes a cylinder 10 in which a piston 12 reciprocates, constrained by a connecting rod 14 which in turn is constrained by a crank 16 on a crankshaft 18.

The piston 12 includes a piston head 11 at its forward end, and a support member in the form of a plurality of rigid columns 20 which rigidly join the piston head 11 to a cross member 13 at the rearward end of the piston 10. The crankshaft 18 is located between the piston head 11 and the cross member 13, such that the piston 12 bridges the crankshaft 18. The connecting rod 14 thus extends from the crankshaft 18 towards the rearward end, with the operative connection of the connecting rod 14 to the piston 12 thus being on the cross member 13 at the rearward end of the piston 12. The mechanism of this arrangement can be referred to as a crank-slider mechanism.

The inlet valve 22 of this embodiment is also one based on a crank-slider mechanism. An inlet valve spool 24 reciprocates within an inlet valve housing 26 which regulates flow from a boiler or other supply of high pressure working fluid (such as supply of high pressure gas, not shown) supplied by a tube 28 into the variable expansion chamber 30 formed by the cylinder 10, the cylinder head 32 and the piston 12 via an inlet port 34. The inlet valve spool 24 is driven by a connecting rod 36 by a crank 38 on the crankshaft 18.

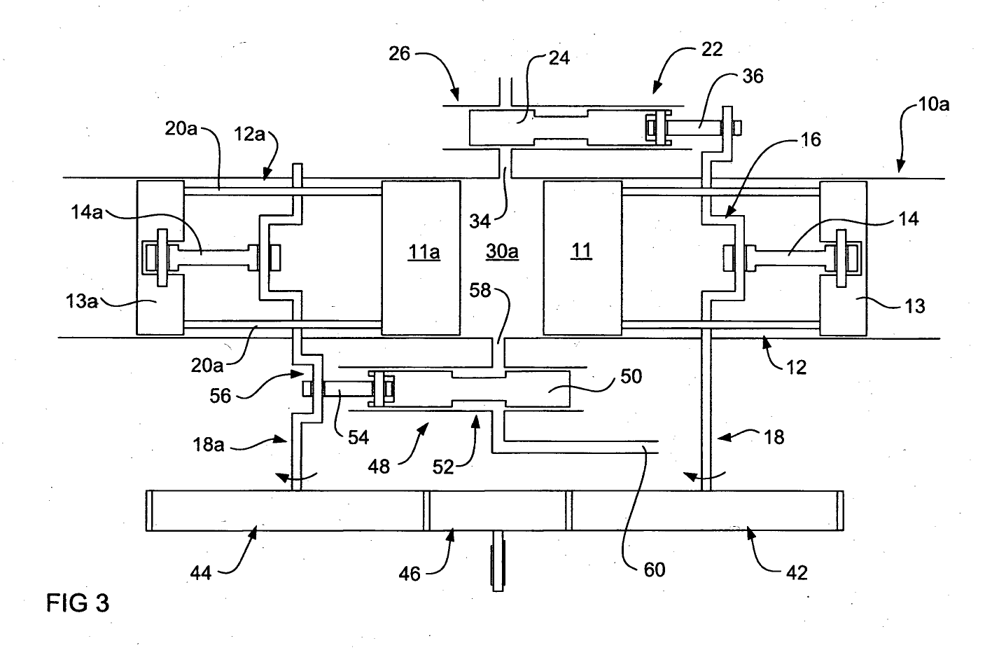

FIG. 2 shows a side view of the first embodiment which better illustrates the operative connection of the piston 12 to the connecting rod 14 on the cross member 13 with a pin 40. Similarly, this view shows the connection of the inlet valve spool 24 to its connecting rod 36 via a pin 42.

In this first embodiment, as the piston 12 approaches TDC (left hand most extent of travel in FIGS. 1 and 2) with the crankshaft 16 rotating in the direction shown in FIG. 1 and the connecting rod 14 pulling the cross member 13 to the left and in turn moving the piston head 11 towards TDC, the inlet valve spool 24 will translate to the left exposing supply pressure at the supply tube 28 to the inlet port 34 just before the piston head 11 reaches TDC, allowing high pressure gas to flow into the expansion chamber 30. This pressure will then urge the piston 12 to the right away from TDC and towards BDC, which will tend to rotate the crankshaft 18 via the force applied to it by the connecting rod 14, with the connecting rod 14 thus pushing the cross member 13 to the right.

After a small amount of travel to the right by the piston 12, the crank 38 will act to close the inlet valve 22 by moving the inlet valve spool 24 to the right, cutting off the supply of high pressure gas to the expansion chamber 30. As the piston 12 continues to move to the right towards BDC, the gas in the expansion chamber 30 will expand whilst continuing to do work on the piston head 11. The piston 12 will travel to its right hand most extent, the BDC position, at or about which time an exhaust valve (not shown in FIGS. 1 and 2) will open allowing the expanded gas to exit the expansion chamber 30.

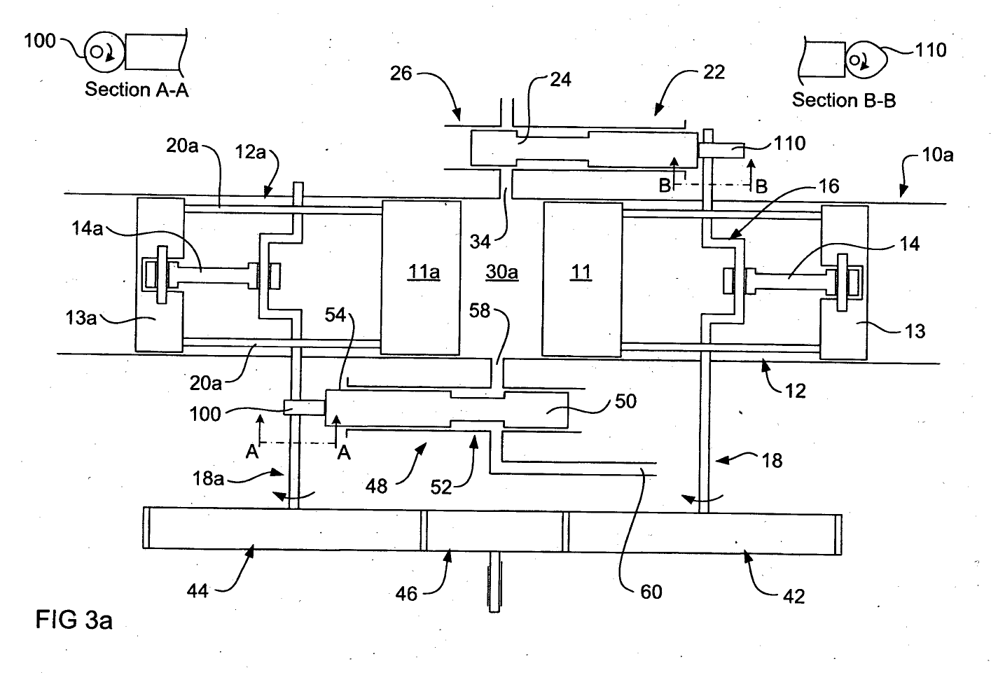

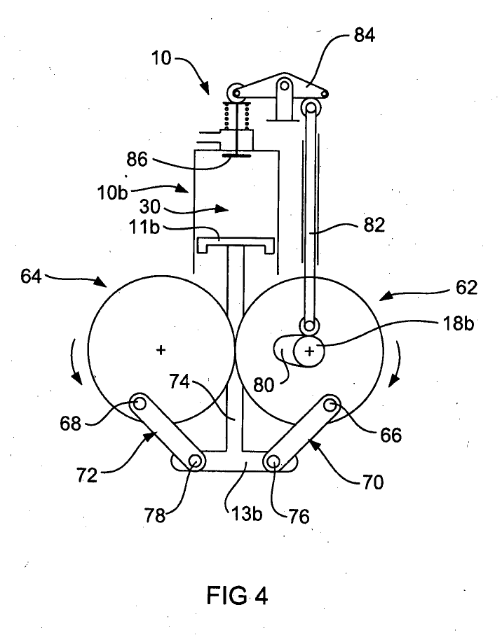

The operation of the embodiment shown in FIG. 1 and FIG. 2 will be further explained with respect to various timing diagrams below, after a description of the further embodiments of FIGS. 3 and 4.

FIG. 3 shows a second preferred embodiment which is similar to the first embodiment (and which thus the same reference numerals for similar aspects) but differs in that the cylinder 10a does not have a cylinder head but instead houses a second piston 12a which reciprocates in an equal and opposite motion to the first piston 12. In this embodiment, the single expansion chamber 30a is formed within the cylinder 10a, between the two opposing faces of the two opposing co-linear piston heads 11 and 11a. The gears 42 and 44 on the crankshafts 18 and 18a are slaved together by a gear 46, constraining the motions of the pistons 12 and 12a to be equal and opposite via their respective connecting rods 14 and 14a.

FIG. 3 also shows an exhaust valve 48 which consists of an exhaust valve spool 50 which reciprocates in the exhaust valve housing 52 under the influence of a connecting rod 54 which is driven by the crank 56 on the crankshaft 18a. The exhaust valve 48 opens when the exhaust valve spool 50 moves sufficiently to the right to allow the exhaust port 58 to communicate with the exhaust outlet 60. The exhaust valve 48 opens at or near BDC of the pistons 12 and 12a allowing expanded gas to be expelled from the single expansion chamber 30a via a single exhaust port 58 and out through the port 60, as the pistons 12 and 12a move back towards TDC. The exhaust valve 48 will preferably close just before TDC and before the inlet valve 22 opens.

Before turning to a discussion of a modification to the second embodiment illustrated in FIG. 3a, a modification not illustrated in either FIG. 3 or FIG. 3a will be briefly discussed. It will be apparent from FIG. 3 that the pistons 12 and 12a in the second embodiment are configured to bridge their respective crankshafts 18 and 18a in the same manner, and with the same effect, as described above in relation to the first embodiment of FIGS. 1 and 2. However, it should be appreciated that another embodiment of the invention (a modification to this second embodiment) may see the second piston 12a not have its own crank-slider mechanism (thus omitting crankshaft 18a), but instead be operatively connected to the crank-slider mechanism of the first piston 12 such that the operation of the crankshaft 18 also acts to dictate the motion of the second piston 12a.

FIG. 3a illustrates a further modification to the embodiment shown in FIG. 3. In FIG. 3a the inlet valve is actuated by a cam 110 which is mounted to and rotates with crankshaft 18. This opens inlet valve spool 24 at a point near TDC for piston 11, 11a and then closes it again shortly afterwards to achieve the desired expansion ratio. In this preferred embodiment, the exhaust valve spool 54 is also actuated by a cam connected to and rotating with crankshaft 18a. The shape of this cam ensures that the exhaust valve 52 opens at around BDC and closes just before TDC of the pistons 11 and 11a.

FIG. 4 shows a third embodiment of the preferred invention. Counter rotating gears 62 and 64 are meshed so that their relative timing is maintained. Each of the gears 62 and 64 have a crankpin 66 and 68 respectively to which are attached connecting rods 70 and 72 respectively. These connect to a piston rod 74 via a cross member 13b and pins 76 and 78 on which the connecting rods 70 and 72 may rotate. The piston rod 74 is connected to the piston head 11b, which reciprocates in a cylinder 10b. The crankshaft 18b is again located between the piston head 11b and the cross member 13b, such that the piston 12b (comprising the piston head 11b, a support member in the form of the piston rod 74, and the cross member 13b) bridges the crankshaft 18. The connecting rods 70 and 72 thus generally extend from the crankshaft 18b towards the rearward end, with the operative connection of the connecting rods 70 and 72 to the piston thus being on the cross member 13b at the rearward end of the piston.

The cam 80 on the gear 62 actuates a push rod 82 that in turn actuates a rocker 84 which opens the exhaust valve 86 against the influence of a spring to allow expanded gas to exit the expansion chamber 30 via an exhaust port 88. A similar valve arrangement (not shown) is actuated by a second cam (also not shown) to allow high pressure gas to enter the expansion volume 30 from a high pressure gas supply means (not shown) for a period of time beginning at TDC (when the expansion volume 30 is at a minimum) or near TDC to shortly after TDC.

This mechanism is known as a rhombic drive mechanism and it will be evident that, with appropriate selection of the crank pin 76 and 78 radii, and the connecting rod 70 and 72 lengths, the motion of the piston head 11b can be provided with a much longer dwell time at TDC than it has at BDC.

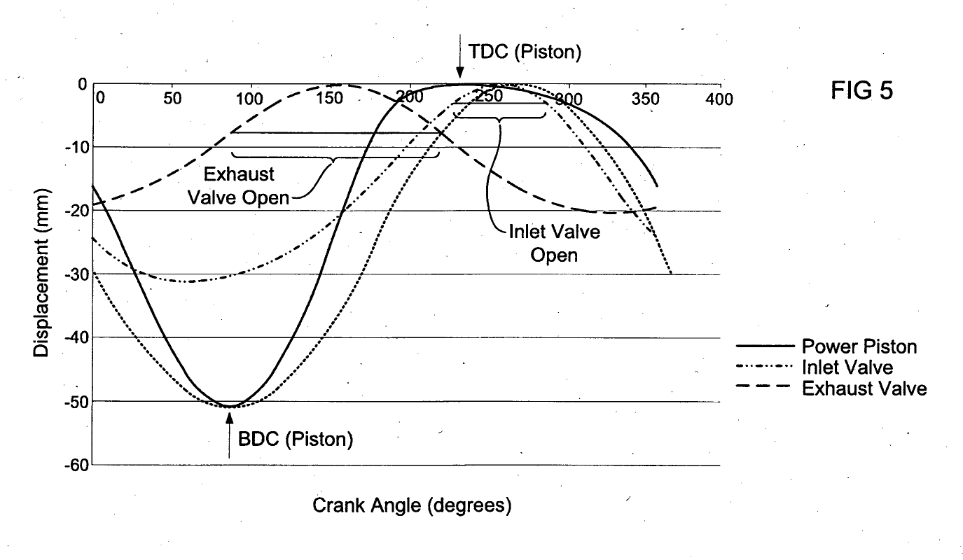

FIG. 5 shows a timing diagram showing how the displacement of a piston, an inlet valve spool, and an exhaust valve spool, all generally in accordance with the present invention, varies over one revolution of a crankshaft. This diagram illustrates the motion for the both the first and second embodiments of the present invention described above, but it is broadly representative of all embodiments of the present invention.

It can be seen in FIG. 5 that the piston (designated “Power Piston” in the key on this Figure) has a long dwell time around TDC relative to the dwell time at BDC. FIG. 5 also shows the point at which the inlet valve opens just before TDC of the piston and closes at around 285 degrees of crankshaft rotation. It can be seen that at the time of inlet valve closing the piston curve is still quite flat, signifying that the piston is moving with relatively low speed. The slope of the inlet valve curve at this point is substantially steeper, signifying that the valve is moving with substantially higher speed. This relative difference in speeds provides a rapid valve closing or “cut-off” which minimises the amount of throttling of high pressure gas being supplied to the expansion chamber. By analysis of FIG. 5 it can also be seen that the inlet valve is open for approximately 55 degrees of crankshaft rotation whilst providing an expansion ratio of approximately 17.5. This is a very long duration for such a high expansion ratio and allows this ratio to be achieved with low peak inlet valve spool accelerations and forces.

It can also be seen in FIG. 5 that the piston dwell time around TDC is not symmetrical in that TDC occurs early in the dwell time rather than at the mid point. This is advantageous in that it allows for greater inlet valve opening time as it is desired to open the inlet valve at or near TDC. This asymmetry is achieved by providing an offset between the crankshaft axis and the cylinder axis, as mentioned above.

FIG. 5 shows also that the exhaust valve is open almost exactly from piston BDC to just before TDC. This allows the expanded gas to be ejected from the expansion chamber on the piston upstroke (ie piston 12 moving to the left in FIGS. 1 and 2).

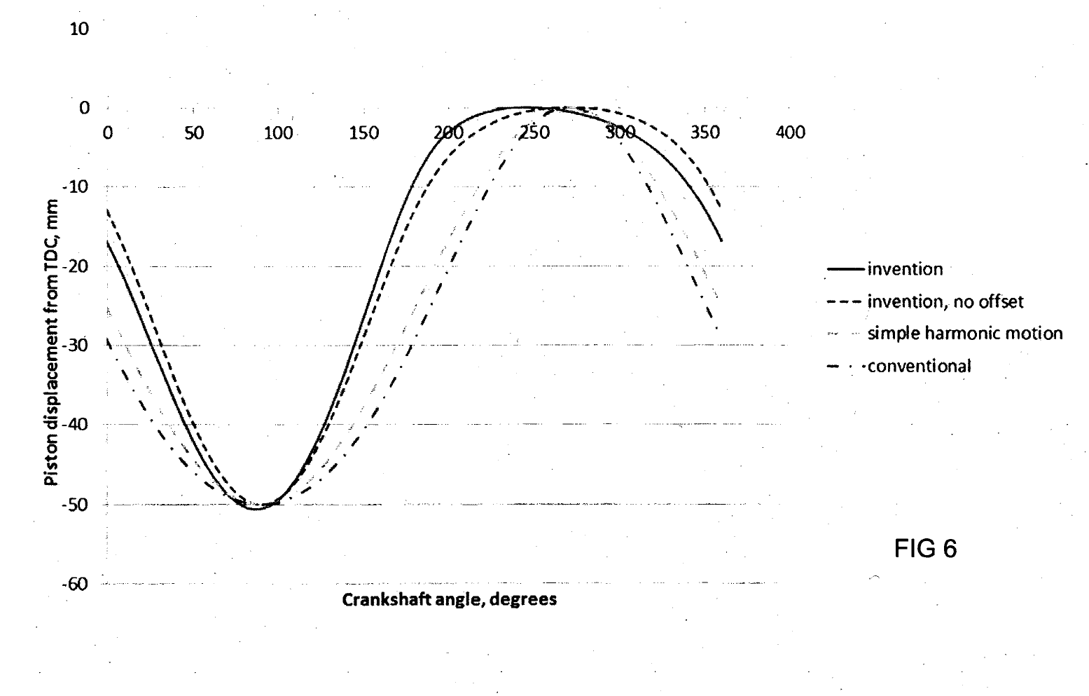

FIG. 6 shows a timing diagram showing how the displacement of a piston varies over one revolution of a crankshaft for an embodiment in accordance with the present invention (designated as “invention” and similar to that shown for the piston displacement in FIG. 5), for an embodiment in accordance with the present invention but without the offset referred to above (designated as “invention, no offset”), for simple harmonic motion (designated as such), and for a conventional expander with a long dwell time at BDC compared to TDC (designated as “conventional”).

It can be seen from FIG. 6 that the curve of the conventional arrangement approaches, but does not reach, simple harmonic motion, and that the dwell time at BDC of the piston of the conventional arrangement is longer than that of simple harmonic motion at BDC and also longer than the dwell time of the same piston at TDC. By comparison, the curves of the two inventive arrangements have longer dwell times at TDC, as is evident by the flattening of the curves of both at TDC, when compared with both the simple harmonic motion curve and the conventional curve at their TDC. Additionally, it can be seen that the dwell time at BDC for both the inventive arrangements is shorter than the dwell time at BDC for both the simple harmonic motion curve and the conventional curve.

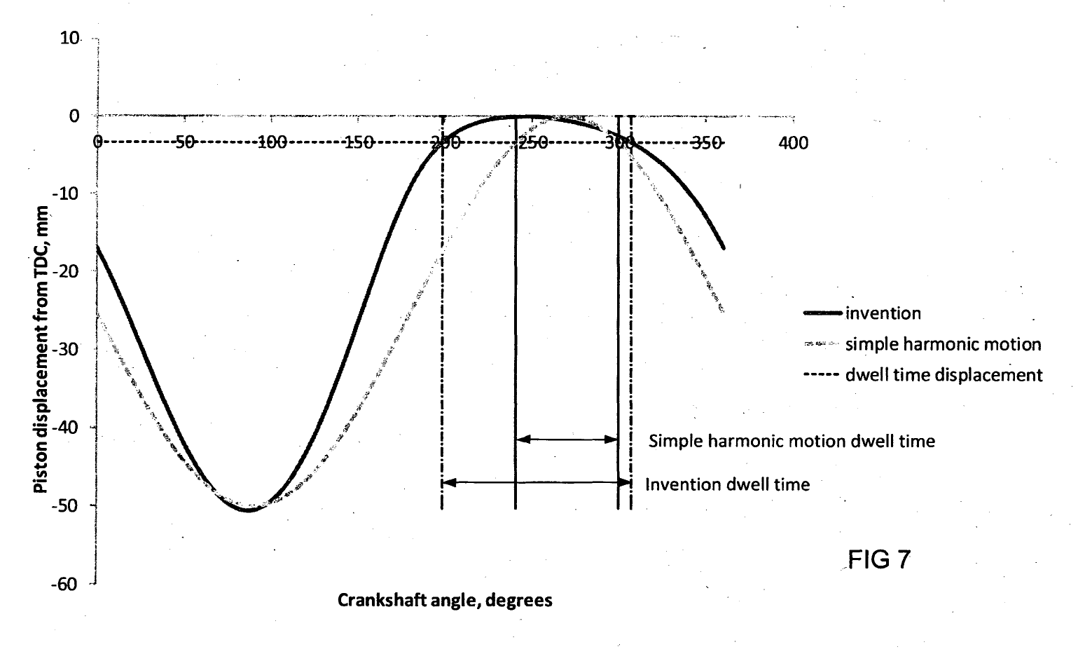

Turning to FIG. 7, which shows only a portion of the curves shown in FIG. 6, and then only the “invention” and “simple harmonic motion” curves, for illustration purposes an arbitrary piston displacement distance, corresponding to inlet valve closing for the desired expansion ratio, has been set (marked in the Figure as “dwell time displacement”). The setting of this arbitrary distance allows a consideration of the time that a piston in an expander in accordance with the present invention is closer to TDC than at the point where the inlet valve closes, then allowing a comparison of that time with simple harmonic motion.

As can be seen, the general flattening of the curve at TDC results in a longer “invention dwell time” than the “simple harmonic motion dwell time”, and as mentioned above, where the former dwell time is to any extent longer than the latter, this is regarded as being a “long dwell time” as called for by the present invention.

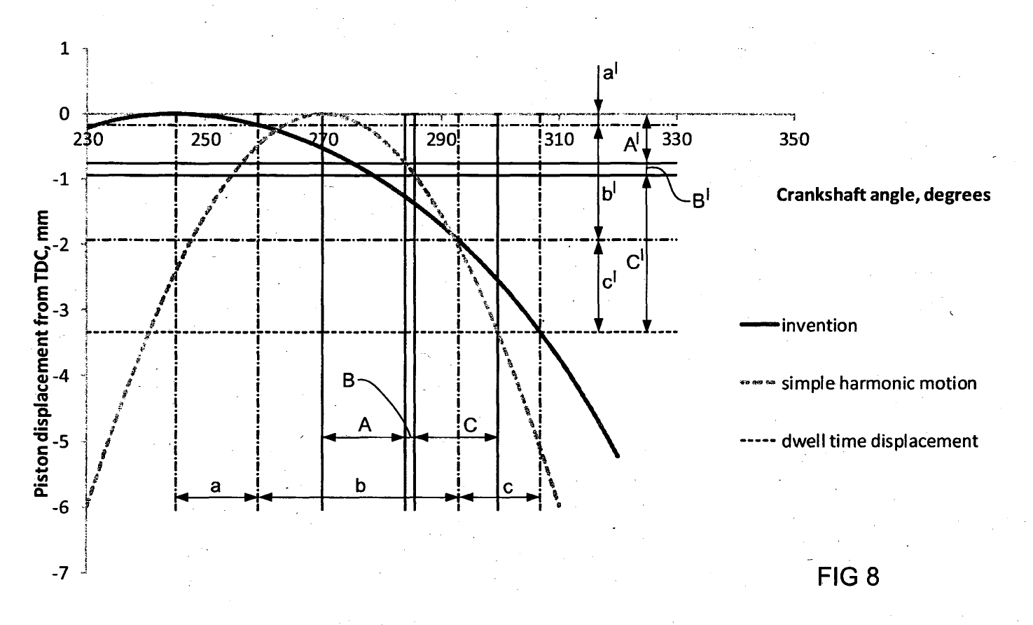

By way of further illustration, FIG. 8 provides a different set of comparisons between an inventive arrangement and simple harmonic motion, again utilising an arbitrarily set “dwell time displacement” line. For this comparison, in both curves, the inlet valve is shown opening precisely at TDC, even though in practice (at least in the invention) the opening of the inlet valve would occur slightly before TDC. In this comparison, and indeed in all the comparisons provided herein, the expansion ratio for both curves is set to be the same, which is 15 in this case.

In both curves, the time assumed for the inlet valve to move from fully closed to fully open is the same (14 degrees of crank rotation), and the time for closing is also set 14 degrees for both. This ensures that the valve has the same time to open/close in both cases at the same engine speed, so valve accelerations, forces, and resulting durability will be the same for the purposes of the comparison.

In FIG. 8, the following references are used (noting that the lower case references represent the invention and the upper case references represent simple harmonic motion):
a,A are used to represent the time (or crank angle) the inlet valve takes to open, with “a” representing the invention and “A” representing simple harmonic motion;
c,C are used to represent the time (or crank angle) the inlet valve takes to close, with “c” representing the invention and “C” representing simple harmonic motion;
b is the time (or crank angle) that the inlet valve is fully open for the invention, while B is the time (or crank angle) that the inlet valve is fully open for simple harmonic motion;
a′ designates the distance travelled by the piston during inlet valve opening for the invention, while A′ designates the distance travelled by the piston during inlet valve opening for simple harmonic motion—it can be seen that a′ is smaller than A′;
c′ designates the distance travelled by the piston during inlet valve closing for the invention, while C′ designates the distance travelled by the piston during inlet valve closing for simple harmonic motion—it can be seen that c′ is smaller than C′; and
b′ and B′ are the respective piston displacements that the inlet valve is fully open for the invention and for simple harmonic motion respectively—it can be seen that B′ is smaller than b′.

Finally, there may be other variations and modifications made to the configurations described herein that are also within the scope of the present invention.

1. An expander for a heat engine, the expander being capable of converting a high pressure gaseous working fluid to useful work, the expander including:
high pressure working fluid supply means;
at least one reciprocating piston reciprocating in a cylinder between top-dead-centre (TDC) and bottom-dead-centre (BDC) with a long dwell time at TDC;
a working fluid inlet valve that opens and closes to introduce, while open, high pressure working fluid from the working fluid supply means into an expansion chamber in the cylinder at or near TDC;
power transfer means that transfers work done on a piston by the working fluid to a form of useful work output; and
an exhaust valve to release expanded working fluid from the expansion chamber to a volume of low pressure working fluid;
wherein piston travel is small during transition of the inlet valve from open to closed and from closed to open.

2. An expander according to claim 1, wherein the piston incorporates a crank-slider mechanism that bridges a crankshaft.

3. An expander according to claim 1, wherein the piston is connected via a connecting rod to a crankshaft such that the crankshaft acts on the connecting rod to pull the piston towards TDC and then to push the piston away from TDC towards BDC.

4. An expander according to any one of claims 1 to 3, wherein the piston has an elongate body with a forward end and a rearward end, there being a piston head at its forward end that provides the piston's working face adjacent the expansion chamber, the crankshaft being configured to be between the forward end and the rearward end of the piston.

5. An expander according to claim 4, wherein a connecting rod is configured to extend from the crankshaft towards the rearward end, with the operative connection of the connecting rod to the piston being at or near the rearward end.

6. An expander according to claim 4, wherein the piston includes a piston head at its forward end and a cross member at its rearward end, with a support member therebetween joining the piston head to the cross member.

7. An expander according to any one of claims 1 to 3, wherein a piston is connected via a connecting rod to a crankshaft, and the axis of rotation of the crankshaft is offset from the centreline of the cylinder.

8. An expander according to claim 1 to 3, wherein a piston and the inlet valve may be operatively linked such that the timing and speed of the opening and closing of the inlet valve occur to the desired extent in response to movement of the piston.

9. An expander according to claim 8, wherein the operative link is provided by the inlet valve and a piston utilising a common crankshaft such that reciprocating motion of the piston directly causes the opening and closing of the inlet valve at the appropriate time and speed.

10. An expander according to claim 1, wherein the inlet valve motion is a reciprocating motion.

11. An expander according to claim 10, wherein the inlet valve includes a valve actuation mechanism that provides a deviation from simple harmonic motion, such that the dwell time at the end of travel associated with the inlet valve being open is short relative to the dwell time at the other end of travel.

12. A method of operating an expander for a heat engine, the expander being capable of converting a high pressure gaseous working fluid to useful work, the method including:
reciprocating at least one piston in a cylinder between top-dead-centre (TDC) and bottom-dead-centre (BDC) with a long dwell time at TDC;
opening an inlet valve to introduce working fluid from a high pressure working fluid supply means into an expansion chamber in the cylinder when the piston is at TDC;
continuing movement of each piston from TDC to BDC under the influence of the working fluid in the expansion chamber, expansion of the working fluid in the expansion chamber thereby doing work on each piston;
closing the inlet valve; and
releasing expanded working fluid from the expansion chamber to a volume of low pressure working fluid via an exhaust valve;
the work on the piston being delivered in a form of useful work output by power transfer means;
wherein piston travel is small during transition of the inlet valve from open to closed and from closed to open.
